(19) United States
(12) Patent Application Publication
(10) Pub. No.: US 2016/0210961 A1
(43) Pub. Date: Jul. 21, 2016

(54) SPEECH INTERACTION DEVICE, SPEECH INTERACTION SYSTEM, AND SPEECH INTERACTION METHOD

(71) Applicant: PANASONIC INTELLECTUAL PROPERTY MANAGEMENT CO., LTD., Osaka (JP)

(72) Inventors: Masahiro NAKANISHI, Kyoto (JP); Takahiro KAMAI, Kyoto (JP); Masakatsu HOSHIMI, Osaka (JP)

(21) Appl. No.: 14/914,383

(22) PCT Filed: Nov. 12, 2014
(86) PCT No.: PCT/JP2014/005689

§ 371 Date: Feb. 25, 2016

(30) Foreign Application Priority Data
Mar. 7, 2014 (JP) 2014-045724

(51) Int. Cl. G10L 13/04; G10L 15/10; G10L 17/22

(52) U.S. Cl. CPC G10L 13/043; G10L 17/22; G10L 15/10; G10L 2015/225

(57) ABSTRACT

A speech interaction device includes: an obtainment unit that obtains utterance data indicating an utterance made by a user; a memory that holds a plurality of keywords; a word determination unit that extracts a plurality of words from the utterance data and determines, for each of the plurality of words, whether or not to match any of the plurality of keywords; a response sentence generation unit that, when the plurality of words include a first word that is determined not to match any of the plurality of keywords, generates a response sentence that includes a second word, which is among the plurality of words and determined to match any one of the plurality of keywords, and asks for re-input of a part corresponding to the first word; and a speech generation unit that generates speech data of the response sentence.

### TECHNICAL FIELD

The present disclosure relates to speech interaction devices, speech interaction systems, and speech interaction methods.

### BACKGROUND ART

An example of automatic reservation systems for automatically reserving facilities, such as accommodations, airline tickets, and the like is a speech interaction system that receives orders made by user's utterances (for example, see Patent Literature (PTL) 1). Such a speech interaction system uses a speech analysis technique disclosed in PTL 2, for example, to analyze user's utterance sentences. The speech analysis technique disclosed in PTL 2 extracts word candidates by eliminating unnecessary sounds, such as “um”, from an utterance sentence.

### CITATION LIST

### Patent Literature

[PTL 1] Japanese Unexamined Patent Application Publication No. 2003-241795
[PTL 2] Japanese Unexamined Patent Application Publication No. H05-197389

### SUMMARY OF INVENTION

### Technical Problem

For automatic reservation systems including such a speech interaction system, improvement of an utterance recognition rate has been demanded.

The present disclosure provides a speech interaction device, a speech interaction system, and a speech interaction method which are capable of improving an utterance recognition rate.

### Solution to Problem

The speech interaction device according to the present disclosure includes: an obtainment unit configured to obtain utterance data indicating an utterance made by a user; a storage unit configured to hold a plurality of keywords; a word determination unit configured to extract a plurality of words from the utterance data and determine, for each of the plurality of words, whether or not to match any of the plurality of keywords; a response sentence generation unit configured to, when the plurality of words include a first word, generate a response sentence that includes a second word and asks for re-input of a part corresponding to the first word, the first word being determined not to match any of the plurality of keywords, and the second word being among the plurality of words and being determined to match any one of the plurality of keywords; and a speech generation unit configured to generate speech data of the response sentence.

### Advantageous Effects of Invention

A speech interaction device, a speech interaction system, and a speech interaction method according to the present disclosure are capable of improving an utterance recognition rate.

### BRIEF DESCRIPTION OF DRAWINGS

FIG. 1 is a diagram illustrating an example of a configuration of a speech interaction system according to an embodiment.

FIG. 2 is a block diagram illustrating an example of a configuration of an automatic order post and a speech interaction server according to the embodiment.

FIG. 3 is a table indicating an example of a menu database (DB) according to the embodiment.

FIG. 4A is a table indicating an example of order data according to the embodiment.

FIG. 4B is a table indicating an example of order data according to the embodiment.

FIG. 4C is a table indicating an example e of order data according to the embodiment.

FIG. 4D is a table indicating an example of order data according to the embodiment.

FIG. 5 is a diagram illustrating an example of a display screen displaying order data according to the embodiment.

FIG. 6 is a flowchart illustrating a processing example of order processing performed by the speech interaction server according to the embodiment.

FIG. 7 is a diagram indicating an example of a dialogue between speeches outputted from a speaker of the automatic order post and a user according to the embodiment.

FIG. 8 is a flowchart illustrating a processing example of utterance sentence analysis performed by the speech interaction server according to the embodiment.

FIG. 9 is a diagram indicating an example of a dialogue between speeches outputted from the speaker of the automatic order post and the user according to the embodiment.

### DESCRIPTION OF EMBODIMENTS

(Details of Problem to be Solved)

For example, a speech interaction system used for product ordering needs to extract at least a “product name” and the “number” of the products. Other items, such as a “size”, may be further necessary depending on products.

If all the items necessary for product ordering have not yet been obtained, the automatic reservation system disclosed in PTL 1 outputs a speech asking for an input of an item that has not yet been obtained.

However, in the case of receiving an order made by an utterance, a part of the utterance cannot be analyzed in some cases, for example, in cases where the utterance has a part not clearly pronounced or where a product name not dealt with is uttered.

If an utterance has a part that cannot be analyzed, a conventional speech interaction system as disclosed in PTL 1 asks a user to input a whole utterance sentence once more, not only the part that cannot be analyzed. In the case where a whole utterance sentence is to be inputted, it is difficult for the user to know which part in the utterance sentence the system has failed to analyze. Therefore, there is a risk that the system fails to analyze the same part again and further asks the user to input the whole sentence. In such a case, it is difficult to shorten a time required for ordering.

The following describes the embodiment in detail with reference to the accompanying drawings. However, there are instances where excessively detailed description is omitted. For example, there are instances where detailed description of well-known matter and redundant description of substantially identical components are omitted. This is to facilitate understanding by a person of ordinary skill in the art by avoiding unnecessary verbosity in the subsequent description.

It should be noted that the accompanying drawings and subsequent description are provided by the inventors to allow a person of ordinary skill in the art to sufficiently understand the present disclosure, and are thus not intended to limit the scope of the subject matter recited in the Claims.

### Embodiment

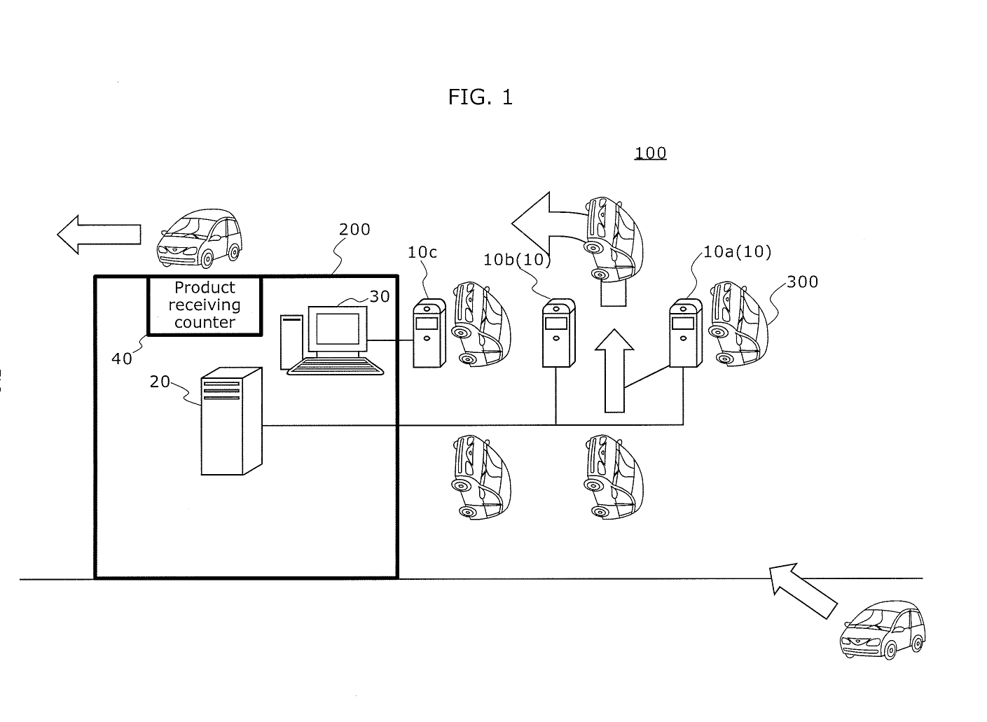

The following describes an embodiment with reference to FIGS. 1 to 9. A speech interaction system according to the present embodiment generates a response sentence including a second word that has successfully been analyzed in a user's utterance sentence, in order to ask the user to further input a first word that has not successfully analyzed in the user's utterance sentence.

In the present embodiment, it is assumed that the speech interaction system is used in a drive-through where the user can buy products without getting out from a vehicle.

[1. Entire Configuration]

FIG. 1 is a diagram illustrating an example of a configuration of the speech interaction system according to the present embodiment.

As illustrated in FIG. 1, the speech interaction system 100 includes automatic order posts 10 provided outside a store 200, and a speech interaction server (speech interaction device) 20 provided inside the store 200. The speech interaction system 100 will be described in more detail later.

The speech interaction system 100 further includes an order post 10c outside the store 200. A user can place an order by communicating directly with store staff through the order post 10c. The speech interaction system 100 still further includes an interaction device 30 and a product receiving counter 40 inside the store 200. The interaction device 30 enables communication between store staff and the user in cooperation with the order post 10c. The product receiving counter 40 is a counter where the user receives ordered products.

The user in a vehicle 300 moves the vehicle 300 to enter a site from a road outside the site, and parks the vehicle beside the order post 10c or the automatic order post 10a or 10b in the site, and places an order using the order post. After fixing the order, the user receives products at the product receiving counter 40.

[1-1. Structure of Automatic Order Post]

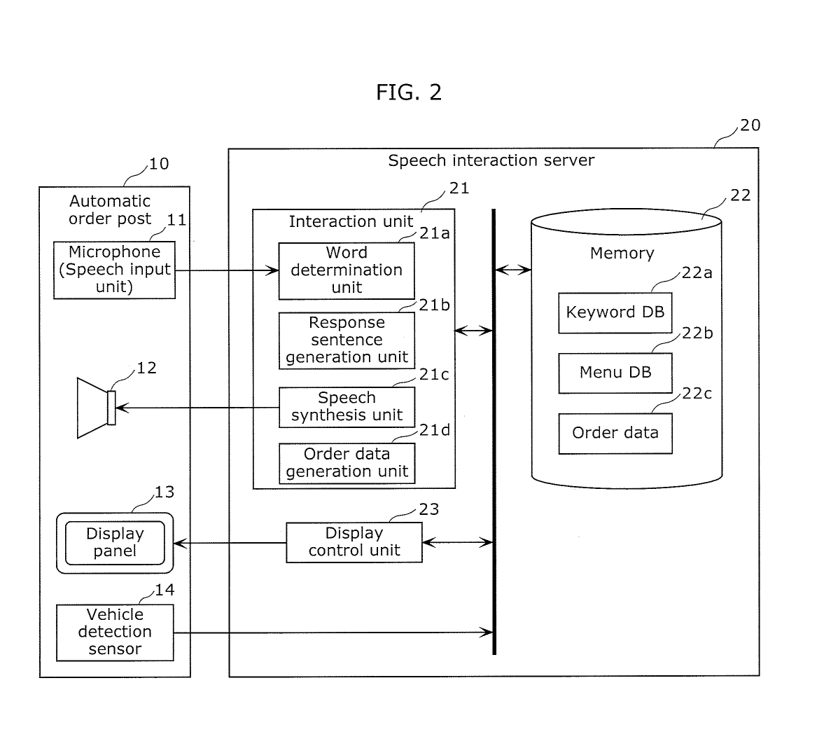

FIG. 2 is a block diagram illustrating an example of a configuration of the automatic order post 10 and the speech interaction server 20 according to the present embodiment.

As illustrated in FIG. 2, the automatic order post 10 includes a microphone 11, a speaker 12, a display panel 13, and a vehicle detection sensor 14.

The microphone 11 is an example of a speech input unit that obtains user's utterance data and provides the utterance data to the speech interaction server 20. More specifically, the microphone 11 outputs a signal corresponding to a user's uttering voice (sound wave) to the speech interaction server 20.

The speaker 12 is an example of a speech output unit that outputs a speech according to speech data provided from the speech interaction server 20.

The display panel 13 displays details of an order received by the speech interaction server 20.

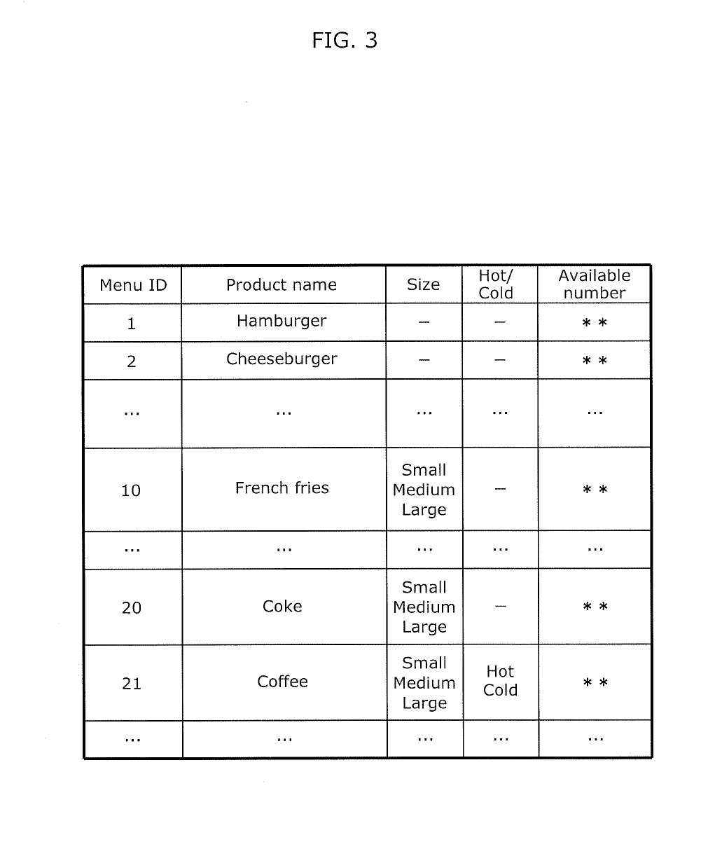

FIG. 3 is a table indicating an example of a screen of the display panel 13. As illustrated in FIG. 3, the display panel 13 displays details of an order that the speech interaction server 20 have successfully been received. The details of the order include an order number, a product name, a size, the number of products, and the like.

An example of the vehicle detection sensor 14 is an optical sensor. For example, optical sensor emits light from a light source, and when the vehicle 300 draws abreast of the order post, detects light reflected on the vehicle 300 to detect whether or not the vehicle 300 is at a predetermined position. When the vehicle detection sensor 14 detects the vehicle 300, the speech interaction server 20 starts order processing. It should be noted that the vehicle detection sensor 14 is not essential in the present disclosure. It is possible to use other sensors, or provide an order start button to the automatic order post 10 to detect a start of ordering performed by a user's operation.

[1-2. Structure of Speech Interaction Server]

As illustrated in FIG. 2, the speech interaction server 20 includes an interaction unit 21, a memory 22, and a display control unit 23.

The interaction unit 21 is an example of a control unit that performs interaction processing with the user. According to the present embodiment, the interaction unit 21 receives an order made by a user's utterance, and thereby generates order data. As illustrated in FIG. 2, the interaction unit 21 includes a word determination unit 21a, a response sentence generation unit 21b, a speech synthesis unit 21c, and an order data generation unit 21d. An example of the interaction unit 21 is an integrated circuit, such as an Application Specific Integrated Circuit (ASIC).

The word determination unit 21a obtains utterance data indicating a user's utterance from a signal provided from the microphone 11 of the automatic order post 10 (in other words, functions also as an obtainment unit), and analyzes the utterance sentence. In the present embodiment, utterance sentences are analyzed by keyword spotting. In the keyword spotting, keywords, which are stored in a keyword database (DB), are extracted from a user's utterance sentence, and the other sounds are discarded as redundant sounds. For example, in the case where “change” is recorded as a keyword for instructing a change, if the user utters “change”, “keyword A”, “to”, and “keyword B”, the utterance is analyzed as an instruction that the keyword A should be changed to the keyword B. Furthermore, for example, the technique disclosed in PTL 1 is used to eliminate unnecessary sounds, such as “um”, from an utterance sentence in order to extract word candidates.

The response sentence generation unit 21b generates an interaction sentence to be outputted from the automatic order post 10. The details will be described later.

The speech synthesis unit 21c is an example of a speech generation unit that generates speech data that is used to allow the speaker 12 of the automatic order post 10 to output, as a speech, an interaction sentence generated by the response sentence generation unit 21b. Specifically, the speech synthesis unit 21c generates a synthetic speech of a response sentence by speech synthesis.

The order data generation unit 21d is an example of a data processing unit that performs predetermined processing, according to an result of utterance data analysis performed by the word determination unit 21a. In the present embodiment, the order data generation unit 21d generates order data, using words extracted by the word determination unit 21a. The details will be described later.

The memory 22 is a recording medium, such as a Random Access Memory (RAM), a Read Only Memory (ROM), or a hard disk. The memory 22 holds data necessary in order processing performed by the speech interaction server 20. More specifically, the memory 22 holds a keyword DB 22a, a menu DB 22b, order data 22c, and the like.

The keyword DB 22a is an example of a storage unit in which a plurality of keywords are stored. In the present embodiment, the plurality of keywords are used to analyze utterance sentences. Specifically, the keyword DB 22a holds a plurality of keywords considered to be used in ordering, for example, words indicating product names, numerical numbers (words indicating the number of products), words indicating sizes, words instructing a change of an already-placed order, such as “change”, words instructing an end of ordering, and the like, although these keywords are not indicated in the figure. It should be noted that the keyword DB 22a may hold keywords not directly related to order processing.

In the present embodiment, the menu DB 22b is a data base in which pieces of information of products dealt with by the store 200 are stored. FIG. 3 is a table indicating an example of the menu DB 22b. As illustrated in FIG. 3, the menu DB 22b holds menu IDs and product names. Each of the menu IDs is associated with selectable sizes and an available number of corresponding products. The menu ID may be further associated with other arbitrary information, such as a designation of hot or cold regarding beverage.

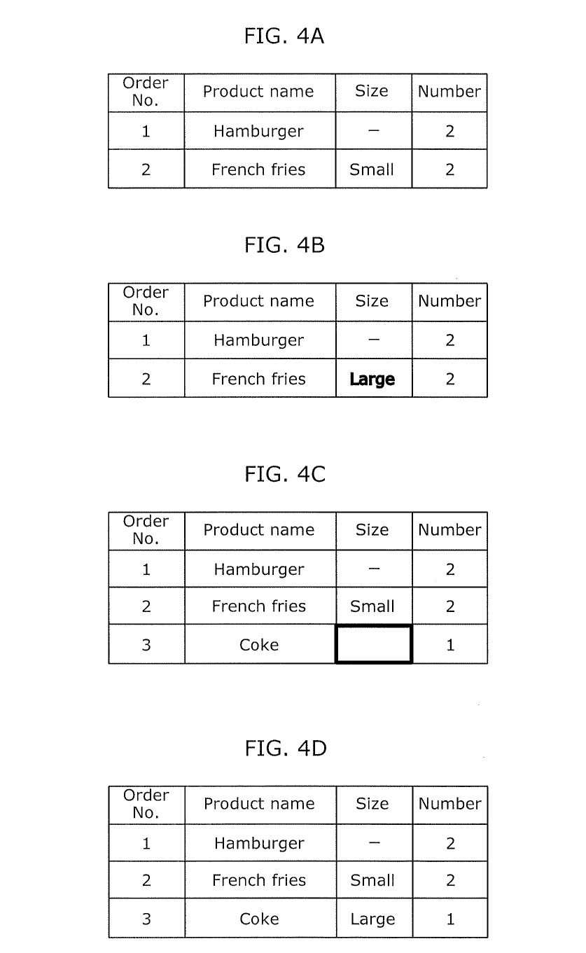

The order data 22c is data indicating details of an order. The order data 22c is sequentially generated each time the user makes an utterance. Each of FIG. 4A to 4D illustrates an example of the order data 22c. The order data 22c includes an order number, a product name, a size, and the number of corresponding products.

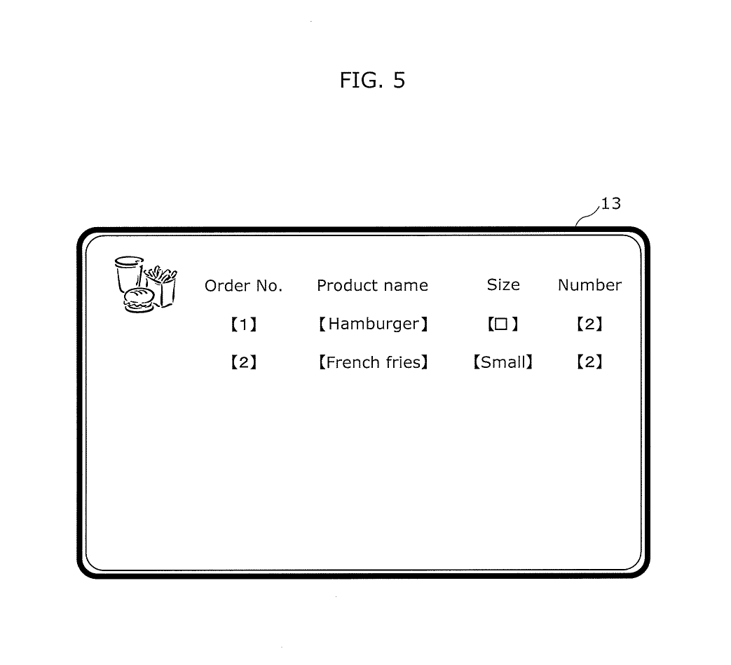

The display control unit 23 causes the display panel 13 of the automatic order post 10 to display order data generated by the order data generation unit 21d. FIG. 5 is a diagram illustrating an example of a display screen on which the order data 22c is displayed. The display screen of FIG. 5 corresponds to FIG. 4A. In FIG. 5, the order numbers, the product names, the size, and the numbers are displayed.

[2. Operation of Speech Interaction Server]

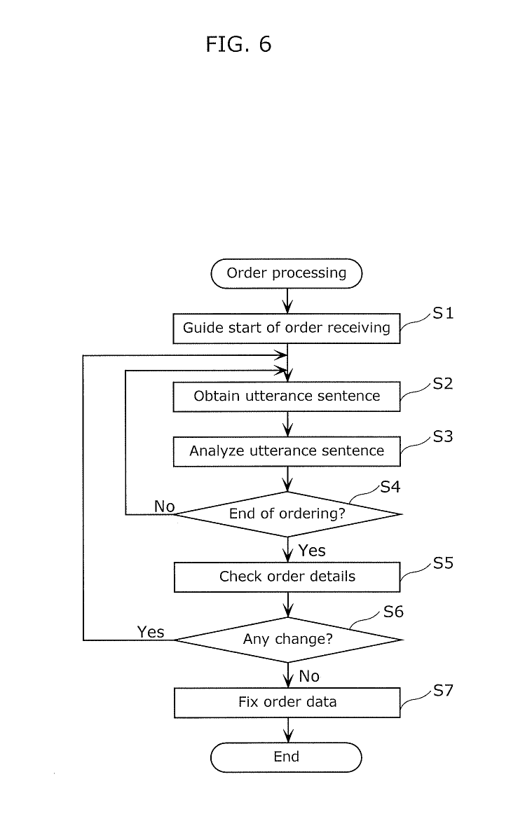

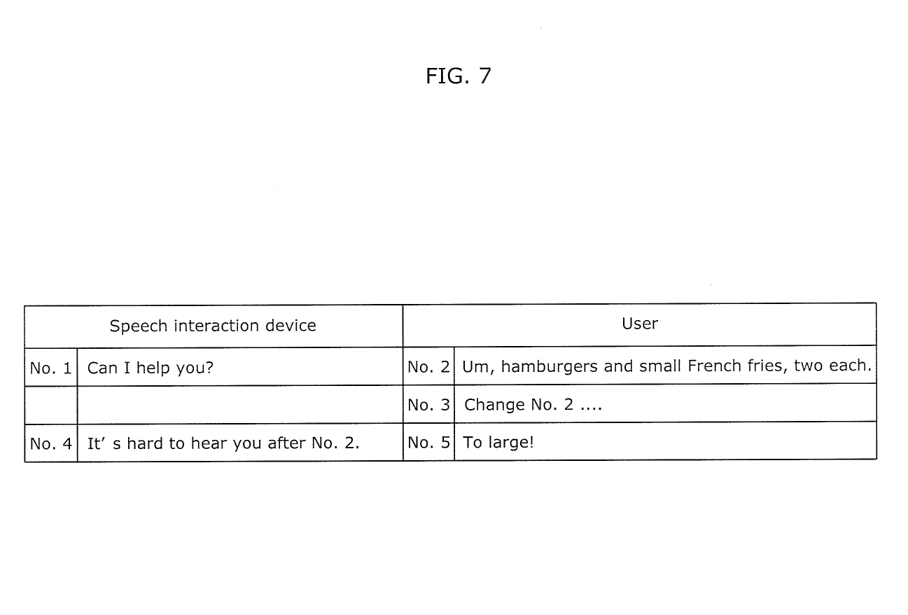

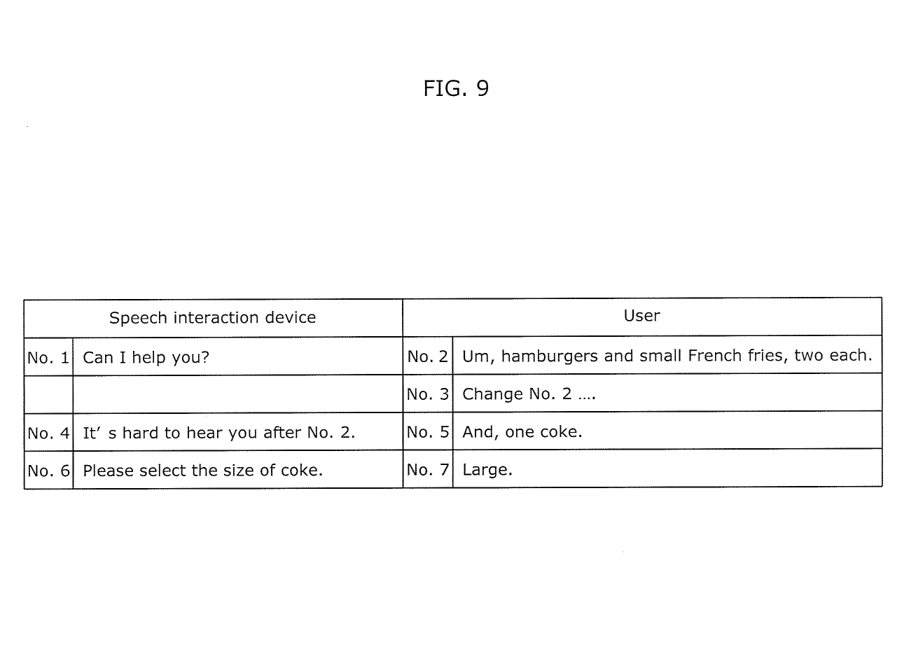

FIG. 6 is a flowchart illustrating a processing example of order processing (speech interaction method) performed by the speech interaction server 20. Each of FIG. 7 and FIG. 9 is a diagram indicating an example of a dialogue between speeches outputted from the speaker 12 of the automatic order post 10 and the user. In FIG. 7 and FIG. 9, the numeric characters indicated in a column to the left of a column in which sentences are indicated represent an order of the sentences in a dialogue. FIG. 7 and FIG. 9 are the same up to No. 4.

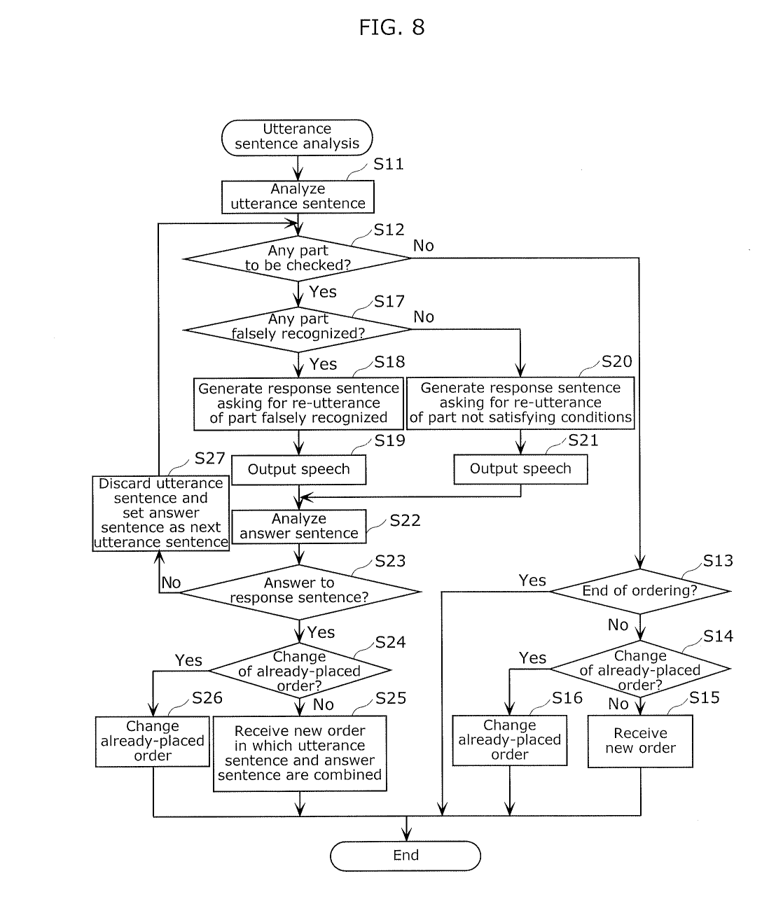

When the vehicle detection sensor 14 detects the vehicle 300, the interaction unit 21 of the speech interaction server 20 starts order processing (S1). At a start of the order processing, as illustrated in FIG. 8, the speech synthesis unit 21c generates speech data by speech synthesis and provides the resulting speech data to the speaker 12 that thereby outputs a speech “Can I help you?”.

The word determination unit 21a obtains an utterance sentence indicating a user's utterance from the microphone 11 (S2), and performs utterance sentence analysis to analyze the utterance sentence (S3). Here, the utterance sentence analysis is performed for each sentence. If the user sequentially utters a plurality of sentences, the utterances are separated to be processed one by one.

FIG. 8 is a flowchart illustrating a processing example of the utterance sentence analysis performed by the speech interaction server 20.

As illustrated in FIG. 8, the word determination unit 21a analyzes an utterance sentence obtained at Step S2 in FIG. 6 (S11). The utterance sentence analysis may use the speech analysis technique of PTL 2, for example.

The word determination unit 21a first eliminates redundant words from the utterance sentence. In the present embodiment, a redundant word means a word not necessary in order processing. Examples of such a redundant word according to the present embodiment include words not directly related to ordering, such as “um”, “hello”, or adjectives, postpositional particles, and the like. The elimination can leave only words necessary in order processing, for example, nouns, such as product names, and words instructing an addition of a new order or words instructing a change of an already-placed order.

For example, if “Um, hamburgers and small French fries, two each.”, which is an utterance sentence No. 2 in the table of FIG. 7, is inputted as an utterance sentence, the word determination unit 21a divides the utterance data into “um”, “hamburgers”, “small”, “French fries”, “two”, and “each”, and eliminates “um” and “and” as redundant words.

The word determination unit 21a extracts remaining word(s) from the utterance data from which the redundant words have been eliminated, and determines, for each of the extracted word(s), whether or not to match any of the keywords stored in the keyword DB 22a.

For example, if the currently-analyzed utterance sentence is No. 2 in the table of FIG. 7, the word determination unit 21a extracts five words, “um”, “hamburgers”, “small”, “French fries”, “two”, and “each”. Furthermore, the word determination unit 21a determines, for each of the five words “hamburgers”, “small”, “French fries”, “two”, and “each”, whether or not to match any of the keywords stored in the keyword DB 22a. Hereinafter, among the extracted words, words not matching any of the keywords stored in the keyword DB 22a are referred to as first words, and words matching any of the keywords are referred to as second words.

Then, the word determination unit 21a determines whether or not the utterance sentence has any part to be checked (S12). In the present embodiment, if the utterance data includes a part falsely recognized or a part not satisfying conditions, it is determined that there is a part to be checked.

The part falsely recognized means a part determined to be a first word. More specifically, examples of a first word include a word that is clear but not found in the keyword DB 22a, and a sound that is unclear, such as “. . . ”.

The part not satisfying conditions means that an order including the part does not satisfy conditions of receiving a product. The order not satisfying the conditions of receiving a product means an order not satisfying conditions set in the menu DB 22b in FIG. 3. For example, if “Two small hamburgers.” is inputted, the word determination unit 21a extracts three words “two”, “small”, and “hamburgers”. In the menu DB 22b in FIG. 3, “hamburger” (an example of the first keyword) is associated with a numerical number (corresponding to the second keyword) in a range from 1 to an available number, but not associated with “small” indicating a size. The word determination unit 21a therefore determines that the utterance sentence includes a second word “small” that is not associated with “hamburger” (an example of the first keyword). Furthermore, for example, if “A hundred of hamburgers.” is inputted, the word determination unit 21a determines that the utterance sentence includes a number greater than an available number, in other words, the utterance sentence includes a second word “hundred” that is not associated with “hamburger (first keyword)”.

As described previously, if a second word not associated with a first keyword is extracted, the word determination unit 21a determines that the second word does not satisfy conditions. Furthermore, if the utterance sentence includes a word indicating a number considered as an abnormal number for one order, the word determination unit 21a also determines that the word does not satisfy conditions.

If it is determined that the utterance sentence includes a part falsely recognized or a part not satisfying conditions, the word determination unit 21a determines that the utterance sentence includes a part to be checked.

In the case of the utterance sentence No. 2 in the table of FIG. 7, it is determined that there is no first word.

If the word determination unit 21a determines that the utterance sentence does not include any part to be checked (No at S12), then the word determination unit 21a determines whether or not the utterance sentence includes a second word indicating an end of ordering (S13). In the case of the utterance sentence No. 2 in the table of FIG. 7, it is determined that the utterance sentence does not indicate an end of the ordering.

If the word determination unit 21a determines that the utterance sentence does not include any second word indicating an end of the ordering (No at S13), then the order data generation unit 21d determines whether or not the utterance sentence indicates a change of an already-placed order (S14). In the case of the utterance sentence No. 2 in the table of FIG. 7, it is determined that the utterance sentence does not indicate a change of an already-placed order.

If it is determined that the utterance sentence does not indicate a change of an already-placed order (No at S14), then the order data generation unit 21d generates data of the utterance sentence as a new order (S15).

In the case of the utterance sentence No. 2 in the table of FIG. 7, the order data illustrated in FIG. 4A is generated. Since the utterance sentence includes two second words indicating product names, two records are generated. One of the records relates to a product name “hamburger”, and the other relates to a product name “French fries”. In a size column of the “hamburger” record, as illustrated in FIG. 3, “−” indicating that a size cannot be designated is inputted because there is no size designation for the product. In a number column of the “hamburger” record, “2” is inputted. Regarding the “French fries” record, “small” is indicated in a size column and “2” is indicated in a number column.

If it is determined that the utterance sentence indicates a change of the already-placed order (Yes at S14), then the order data generation unit 21d changes the already-placed order (S16).

After updating the order data, as illustrated in FIG. 6, it is determined whether or not the utterance sentence indicates an end of the ordering (S4). In this example, since it has been determined at Step S13 in FIG. 8 that the utterance sentence does not include any second word indicating an end of the ordering (No at S4), the processing returns to Step S2 and a next utterance sentence is obtained (S2).

The word determination unit 21a obtains the next utterance sentence of the user from the microphone 11 (S2), and performs utterance sentence analysis to analyze the utterance sentence (S3).

As illustrated in FIG. 8, the word determination unit 21a analyzes the utterance sentence obtained at Step S2 of FIG. 6 (S11).

If “Change No. 2 . . . . ” which is No. 3 in the table of FIG. 7 is inputted as the utterance sentence, “change” and “No. 2” are extracted as second words, and “ . . . ” is extracted as a first word.

The speech interaction server 20 determines whether or not the utterance sentence has a part to be checked (S12). In the case of the utterance sentence No. 3 in the table of FIG. 7, since there is “ . . . ” that is a part to be checked, it is determined that the utterance sentence includes a first word.

If the utterance sentence has a part to be checked (YES at S12), then the speech interaction server 20 determines whether or not the part to be checked is a part falsely recognized (S17).

If the word determination unit 21a determines that the part determined at Step S12 to be checked is a part falsely recognized (YES at S17), then the response sentence generation unit 21b generates a response sentence asking for re-utterance of the part falsely recognized (S18).

The response sentence generation unit 21b according to the present embodiment generates a response sentence including a second word extracted from the utterance sentence that has been determined to have a part falsely recognized. In the case of the utterance sentence No. 3 in the table of FIG. 7, since “change” and “No. 2” are extracted as second words, a response sentence “It's hard to hear you after No. 2.” (response sentence No. 4 in the table) is generated by using “No. 2” that is a second word uttered immediately prior to “ . . . ”. More specifically, a fixed sentence having a part in which a second word is applied, such as “It's hard to hear you after [second word].”, is prepared, and the extracted second word is applied in the [second word] part to generate a response sentence.

It should be noted that an extracted second word uttered immediately after “ . . . ” may be used in the [second word] part. In this case, a fixed sentence is “It's hard to hear you before [second word].” For example, if a second word uttered immediately prior to “ . . . ” appears a plurality of times in the same utterance sentence, or if no second word is uttered immediately prior to “ . . . ”, it is possible to generate a response sentence including a second word uttered immediately after “ . . . ”.

It is also possible to generate a response sentence including plural kinds of second words, such as “It's hard to hear you after [second word] and before [second word].”

The speech synthesis unit 21c generates speech data of the response sentence generated at Step S18 and causes the speaker 12 to output the speech data (S19).

If the word determination unit 21a determines that the part determined at Step S12 to be checked is a part not satisfying conditions (No at S17), then the response sentence generation unit 21b generates a response sentence including the conditions to be satisfied (S20).

For example, if the above-mentioned utterance sentence “Two small hamburgers.” is inputted, the word determination unit 21a determines at Step S12 that a size “small” that cannot be designated (not usable in the utterance sentence) is designated. Therefore, the response sentence generation unit 21b generates a response sentence including the conditions to be satisfied, for example, “The size of hamburgers cannot be designated.”

Moreover, for example, if the utterance sentence “A hundred of hamburgers.” as mentioned previously is inputted, the word determination unit 21a determines at Step S12 that the number greater than an available number is designated. In this case, the response sentence generation unit 21b generates a response sentence including the available number of the products for one order (an example of the conditions to be satisfied, an example of the second keyword), for example “ten”. The response sentence generation unit 21b generates, for example, a response sentence, such as “Please designate the number of hamburgers within [ten].”

The speech synthesis unit 21c generates speech data of the response sentence generated at Step S20 and causes the speaker 12 to output the speech data (S21).

After performing Step S19 or Step S21, the word determination unit 21a obtains an answer sentence indicating a user's utterance from the microphone 11, and analyzes the answer sentence (S22).

Then, the speech interaction server 20 determines whether or not the answer sentence is an answer to the response sentence (S23).

Here, in the case where the answer sentence is No. 3 in the table of FIG. 7, in other words, the answer sentence includes “change”, “No. 2”, and “ . . . ”, the word “change” is a second word indicating a change. Therefore, the answer sentence is expected to be an instruction that a size or the number of the French fries ordered by No. 2 should be changed. In this case, the answer sentence answering to the response sentence is expected to include a size that can be designated for French fries, namely, “small”, “medium”, or “large”. If the answer sentence does not include any word expected as an answer to the response sentence, or if the answer sentence includes a product name, for example, it is determined that the answer sentence is not an answer to the response sentence.

For example, if the answer sentence is “To large” that is No. 5 in the table of FIG. 7, the speech interaction server 20 determines that the answer sentence is an answer to the response sentence.

On the other hand, if the answer sentence is “And, one coke.” that is No. 5 in the table of FIG. 9, the speech interaction server 20 extracts two second words “one” and “coke”. In this case, since the product name “coke” is extracted, it is determined that the utterance sentence is not an answer to the response sentence.

If the answer sentence is an answer to the response sentence (Yes at S23), then the speech interaction server 20 determines whether or nor not the answer sentence indicates a change of the already-placed order (S24). In the case of the answer sentence No. 5 in the table in FIG. 7, it is determined that the answer sentence indicates a change of the already-placed order.

If it is determined that the utterance sentence indicates a change of the already-placed order (Yes at S24), then the order data generation unit 21d changes the order data of the already-placed order (S26). In the case of the answer sentence No. 5 in the table of FIG. 7, the size data in No. 2 is changed from “small” to “large” as seen in FIG. 4B. On the other hand, it is determined that the utterance sentence does not indicate a change of the already-placed order (No at S24), then the order data generation unit 21d generates data of the utterance sentence as a new order (S25).

If it is determined that the utterance sentence is not an answer to the response sentence (No at S23), then the speech interaction server 20 discards the utterance sentence analyzed at S11, sets the answer sentence obtained at S22 as a next utterance sentence, and the utterance sentence analysis is performed on the next utterance sentence (S27). In the case where the answer sentence is No. 5 in the table of FIG. 9, the answer sentence “And, one coke.” is set as the next utterance sentence.

The speech interaction server 20 determines, based on the result of the analysis of the answer sentence at Step S22, whether or not the utterance sentence (namely, the answer sentence) has any part to be checked (S12). In the case where the utterance sentence is No. 5 in the table of FIG. 9, it is determined that the utterance sentence does not include any part to be checked, and the processing proceeds to Step S13.

As described above, if the utterance sentence does not have any part to be checked (No at S12), the speech interaction server 20 determines whether or not the utterance sentence includes a second word indicating an end of the ordering (S13). In the case where the utterance sentence is No. 5 in the table in FIG. 9, it is determined that the utterance sentence does not indicate an end of the ordering. Furthermore, in the case of the utterance sentence No. 5 in the table of FIG. 9, since the utterance sentence does not instruct a change of the already-placed order (No at S14), order data of the utterance sentence is updated as new order (S15).

Here, in the case of No. 5 in the table of FIG. 9, “one” and “coke” are extracted as second words, and the record indicated as the order number 3 in FIG. 4C is generated. Here, since a coke needs size designation but the utterance sentence does not include any second word indicating a size. Therefore, the response sentence generation unit 21b generates speech data of a response sentence “Please designate a size of coke.” for asking the user to utter a size, and causes the speaker 12 to output the speech data. As seen in No. 7 in the table of FIG. 9, if a coke size “Large” is uttered and inputted via the microphone 11, the order data generation unit 21d generates the order data indicated in FIG. 4D.

Referring back to FIG. 6, if it is analyzed in the utterance sentence analysis at Step S3 that a currently-analyzed utterance sentence does not include a keyword indicating an end of the ordering (No at S4), then the processing proceeds to Step S2 and the word determination unit 21a obtains a next utterance sentence.

On the other hand, if it is analyzed in the utterance sentence analysis that the utterance sentence includes a keyword indicating an end of the ordering (Yes at S4), then details of the order are checked (S5). More specifically, the response sentence generation unit 21b generates speech data that inquires whether or not to make a change in the utterance sentence, and causes the speaker 12 to output a speech of the speech data.

If a change is to be made (Yes at S6), then the speech interaction server 20 returns to Step S2 and receives details of the change.

On the other hand, if there is no change (No at S6), then the speech interaction server 20 fixes the order data (S7). When the order data is fixed, the store 200 prepares ordered products. The user moves the vehicle 300 to the product receiving counter 40, pays, and receives the products.

[3. Effects Etc.]

If it is determined that utterance data has a part falsely recognized, the speech interaction server (speech interaction device) 20 according to the present embodiment generates a response sentence including a part not heard among the utterance data. This makes it possible to ask for re-utterance of only the part to be checked. As a result, an utterance recognition rate can be improved.

If the user is asked to re-utter the whole utterance sentence, it is difficult for the user to know which part the speech interaction server 20 has failed to recognize. Therefore, there is a possibility that the user has to repeat the same utterance. In contrast, the speech interaction server 20 according to the present embodiment can ask the user to re-utter only a part to be checked. Therefore, the user can clearly understand which part the speech interaction server has failed to recognize. As a result, it is possible to effectively prevent further occurrence of the part to be checked. By asking for utterance of only a part to be checked, a resulting answer sentence becomes a sentence including only a word or very short. Therefore, an utterance recognition rate can be improved. The improvement of utterance recognition rate allows the speech interaction server 20 according to the present embodiment to decrease a time required for whole order processing.

Furthermore, when an utterance sentence uttered after a response sentence is different from an answer candidate, the speech interaction server 20 according to the present embodiment discards utterance data of an immediately-previous utterance sentence. This is because it is considered that, when a currently-analyzed utterance sentence, which is uttered after a response sentence in response to an immediately-previous utterance sentence, is not an answer candidate, the user often cancels utterance data of the immediately-previous utterance sentence. Therefore, this discarding can facilitate user's processing of canceling the immediately-previous utterance sentence, for example.

Furthermore, for example, if an order not complied with the menu DB 22b is placed, for example, the number of ordered products exceeds one hundred, the speech interaction server 20 according to the present embodiment generates a response sentence including an available number of the products for one order. As a result, the user can easily make an utterance complied with the conditions.

### Other Embodiments

Thus, the embodiment has been described as an example of the technique disclosed in the present application. However, the technique according to the present disclosure is not limited to the embodiment, and appropriate modifications, substitutions, additions, or eliminations, for example, may be made in the embodiment. Furthermore, the structural components described in the embodiment may be combined to provide a new embodiment.

The following describes such other embodiments.

(1) Although the speech interaction server is provided at a drive-through in the foregoing embodiment, the present invention is not limited to this example. For example, the speech interaction server according to the foregoing embodiment may be applied to reservation systems for airline tickets which are set in facilities such as airports and convenience stores, and reservation systems for reserving accommodations.

(2) Although the interaction unit 21 of the speech interaction server 20 has been described to include an integrated circuit, such as an ASIC, the present invention is not limited to this. The interaction unit 21 may include a system Large Scale Integration (LSI) or the like. It is also possible that the interaction unit 21 is implemented by a Central Processing Unit (CPU) executing a computer program (software) defining functions of the word determination unit 21a, the response sentence generation unit 21b, the speech synthesis unit 21c, and the order data generation unit 21d. The computer program may be transmitted via a network represented by a telecommunication line, a wireless or wired communication line, and the Internet, data broadcasting, or the like.

(3) Although it has been described in the foregoing embodiment that the speech interaction server 20 is provided in the store 200, the speech interaction server 20 may be provided to the automatic order post 10, or provided outside the store 200 and is connected to the devices and the automatic order post 10 in the store 200 via a network. Furthermore, each of the structural components of the speech interaction server 20 is not necessarily provided in the same server, and may be separately provided in a computer on a cloud service, a computer in the store 200, and the like.

(4) Although the word determination unit 21a performs speech recognition processing, in other words, processing for converting speech signal collected by the microphone 11 to text data in the foregoing embodiment, the present invention is not limited to this example. The speech recognition processing may be performed by a different processing module that is separate from the interaction unit 21 or from the speech interaction server 20.

(5) Although the interaction unit 21 includes the speech synthesis unit 21c in the foregoing embodiment, the speech synthesis unit 21c may be a different processing module that is separate from the interaction unit 21 or from the speech interaction server 20. Each of the word determination unit 21a, the response sentence generation unit 21b, the speech synthesis unit 21c, and the order data generation unit 21d which are included in the interaction unit 21 may be a different processing module that is separate from the interaction unit 21 or from the speech interaction server 20.

Thus, the embodiments have been described as other examples of the technique according to the present disclosure. The accompanying drawings and the detailed description are therefore given. Therefore, in order to provide the examples of the technique, among the structural components illustrated in the accompanying drawings and described in the detailed description, there may be structural components not essential to solve the problem as well as essential structural components. It is therefore not reasonable to easily consider these unessential structural components as essential merely because the elements are illustrated in the accompanying drawings or described in the detailed description.

It should also be noted that, since the foregoing embodiments exemplify the technique according to the present disclosure, various modifications, substitutions, additions, or eliminations, for example, may be made in the embodiments within a scope of the appended claims or within a scope of equivalency of the claims.

### INDUSTRIAL APPLICABILITY

The present disclosure can be applied to speech interaction devices and speech interaction systems for analyzing user's utterances and automatically performing order receiving, reservations, and the like. More specifically, for example, the present disclosure can be applied to systems provided at drive-throughs, systems for ticket reservation which are provided in facilities such as convenience sores, and the like.

### REFERENCE SIGNS LIST

10, 10a, 10b automatic order post
10c order post
11 microphone
12 speaker
13 display panel
20 speech interaction server
21 interaction unit
21a word determination unit
21b response sentence generation unit
21c speech synthesis unit
21d order data generation unit
22 memory
22a keyword DB
22b menu DB
22c order data
23 display control unit
30 interaction device
40 product receiving counter
100 speech interaction system
200 store
300 vehicle

1. A speech interaction device comprising:
an obtainment unit configured to obtain utterance data indicating an utterance made by a user;
a storage unit configured to hold a plurality of keywords;
a word determination unit configured to extract a plurality of words from the utterance data and determine, for each of the plurality of words, whether or not to match any of the plurality of keywords;
a response sentence generation unit configured to, when the plurality of words include a first word, generate a response sentence that includes a second word and asks for re-input of a part corresponding to the first word, the first word being determined not to match any of the plurality of keywords, and the second word being among the plurality of words and being determined to match any one of the plurality of keywords; and
a speech generation unit configured to generate speech data of the response sentence,
wherein the storage unit is configured to hold a first keyword and a second keyword in association with each other, the first keyword and the second keyword being included in the plurality of keywords, and
the response sentence generation unit is configured to, when the word determination unit extracts, from the utterance data, a second word matching the first keyword and another second word not matching the second keyword associated with the first keyword, determine that the other second word not matching the second keyword is not usable in the utterance data, and generate the response sentence including a condition to be satisfied for the second word associated with the first keyword.

2. The speech interaction device according to claim 1,
wherein the obtainment unit is further configured to obtain answer data indicating an other utterance made by the user which is uttered after output of the speech data of the response sentence,
the speech interaction device further includes
a data processing unit configured to obtain one or more answer candidates answering the response sentence, and when the answer data does not match any of the one or more answer candidates, discard the utterance data.

3. The speech interaction device according to claim 1,
wherein the response sentence including the condition to be satisfied includes the second keyword.

4. The speech interaction device according to claim 1,
wherein the word determination unit is configured to extract the plurality of words from the utterance data after eliminating a redundant word from the utterance data.

5. A speech interaction system comprising:
the speech interaction device according to claim 1; and
an automatic order post including: a speech input unit configured to receive the utterance data of the user and provide the utterance data to the speech interaction device; and a speech output unit configured to output a speech according to the speech data.

6. A speech interaction method performed by a speech interaction device that includes a database holding a plurality of keywords and a control unit which performs interaction processing with a user, the speech interaction method comprising:
obtaining, by the control unit, utterance data of the user;
extracting a plurality of words from the utterance data, and determining, for each of the plurality of words, whether or not to match any of the plurality of keywords, the extracting and the determining being performed by the control unit;
when the plurality of words include a first word, generating, by the control unit, a response sentence that includes a second word among the plurality of words and asks for re-input of a part corresponding to the first word, the first word being determined not to match any of the plurality of keywords, and the second word being determined to match any one of the plurality of keywords; and
generating, by the control unit, speech data of the response sentence by speech synthesis,
wherein a first keyword and a second keyword among the plurality of keywords are in association with each other, and
when a second word matching the first keyword and another second word not matching the second keyword associated with the first keyword are extracted from the utterance data, the generating of the response sentence includes: determining that the other second word not matching the second keyword is not usable in the utterance data and generating the response sentence including a condition to be satisfied for the second word associated with the first keyword.
